(19) United States
(12) Patent Application Publication
(10) Pub. No.: US 2004/0072055 A1
(43) Pub. Date: Apr. 15, 2004

(54) Graphite article useful as a fuel cell component substrate

(76) Inventors: Matthew George Getz, Medina, OH (US); Robert Angelo Mercuri, Seven Hills, OH (US)

Correspondence Address: Waddey & Patterson, P.C., Bank of America Plaza, Suite 2020, 414 Union Street, Nashville, TN, 37219, US

(21) Appl. No.: 10/260,748

(22) Filed: Sep. 30, 2002

Related U.S. Application Data
(63) Continuation-in-part of application No. 09/549,865, filed on Apr. 14, 2000, now Pat. No. 6,528,199.

(51) Int. Cl. H01M 8/02; B26D 3/06

(52) U.S. Cl. 429/38; 83/875

(57) ABSTRACT

A graphite article in the form of a flexible graphite sheet having transverse fluid channels passing through the sheet and a groove formed in one of the surfaces of the sheet communicating with a plurality of the transverse fluid channels is presented, wherein the open groove comprises a groove floor and groove walls, the groove walls having transverse fluid channels passing therethrough.

### RELATED APPLICATION

The present application is a continuation-in-part of copending and commonly assigned U.S. patent application having Ser. No. 09/549,865, filed Apr. 14, 2000, the disclosure of which is incorporated by reference herein in its entirety.

### TECHNICAL FIELD

The present invention relates to an article formed of a grooved flexible graphite sheet which is fluid permeable in the transverse direction and has enhanced isotropy with respect to thermal and electrical conductivity. The article of the present invention is useful in the formation of a component for an electrochemical fuel cell.

### BACKGROUND OF THE INVENTION

An ion exchange membrane fuel cell, more specifically a proton exchange membrane (PEM) fuel cell, produces electricity through the chemical reaction of hydrogen and oxygen in the air. Within the fuel cell, electrodes, denoted as anode and cathode, surround a polymer electrolyte to form what is generally referred to as a membrane electrode assembly, or MEA. Oftentimes, the electrodes also function as the gas diffusion layer (or GDL) of the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell includes a membrane electrode assembly sandwiched between two flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, the fuel, especially hydrogen, flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

It has been disclosed that a graphite sheet that has been provided with channels, which are preferably smooth-sided, and which pass between the parallel, opposed surfaces of the flexible graphite sheet and are separated by walls of compressed expandable graphite, can be used to form gas diffusion layers for PEM fuel cells. As taught by Mercuri, Weber and Warddrip in U.S. Pat. No. 6,413,671, the disclosure of which is incorporated herein by reference, the channels can be formed in the flexible graphite sheet at a plurality of locations by a compressive mechanical impact, such as by use of rollers having truncated protrusions extending therefrom. That pattern can be devised in order to control, optimize or maximize fluid flow through the channels, as desired. For instance, the pattern formed in the flexible graphite sheet can comprise selective placement of the channels, or it can comprise variations in channel density or channel shape in order to, for instance, reduce or minimize flooding, equalize fluid pressure along the surface of the electrode when in use, or for other purposes. See, for instance, Mercuri and Krassowski in International Publication No. WO 02/41421 A1.

Compressive force may also be used to form the continuous reactant flow groove in the material used to form a flow field plate (hereinafter “FFP”). Typically an embossing tool is used to compress the graphite sheet and emboss the groove in the sheet. Unlike, the GDL, the groove(s) in the FFP do not extend through the FFP from one opposed surface to a second surface. Typically, the groove(s) is on one surface of the FFP.

Graphites are made up of layer planes of hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. Graphites exhibit anisotropy because of their inherent structures and thus exhibit or possess many properties, like thermal and electrical conductivity and fluid diffusion, that are highly directional. Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The natural graphites most suitable for manufacturing flexible graphite possess a very high degree of orientation.

As noted above, the bonding forces holding the parallel layers of carbon atoms together are only weak van der Waals forces. Graphites can be treated so that the spacing between the superposed carbon layers or laminae can be appreciably opened up so as to provide a marked expansion in the direction perpendicular to the layers, that is, in the “c” direction and thus form an expanded or intumesced graphite structure in which the laminar character of the carbon layers is substantially retained.

Natural graphite flake which has been expanded and more particularly expanded so as to have a final thickness or “c” direction dimension which is at least about 80 or more times the original “c” direction dimension can be formed without the use of a binder into cohesive or integrated flexible graphite sheets of expanded graphite, e.g. webs, papers, strips, tapes, or the like. The formation of graphite particles which have been expanded to have a final thickness or “c” dimension which is at least about 80 times the original “c” direction dimension into integrated flexible sheets by compression, without the use of any binding material is believed to be possible due to the excellent mechanical interlocking, or cohesion which is achieved between the voluminously expanded graphite particles.

In addition to flexibility, the sheet material, as noted above, has also been found to possess a high degree of anisotropy with respect to thermal and electrical conductivity and fluid diffusion, comparable to the natural graphite starting material due to orientation of the expanded graphite particles substantially parallel to the opposed faces of the sheet resulting from very high compression, e.g., roll pressing. Sheet material thus produced has excellent flexibility, good strength and a very high degree of orientation.

Briefly, the process of producing flexible, binderless anisotropic graphite sheet material, such as web, paper, strip, tape, foil, mat, or the like, comprises compressing or compacting under a predetermined load and in the absence of a binder, expanded graphite particles which have a “c” direction dimension which is at least about 80 times that of the original particles so as to form a substantially flat, flexible, integrated graphite sheet. The expanded graphite particles, which generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 5 pounds per cubic foot to about 125 pounds per cubic foot. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal, electrical and fluid diffusion properties of the sheet are very different, by orders of magnitude, for the “c” and “a” directions.

### SUMMARY OF THE INVENTION

In accordance with the present invention, a graphite article is provided, comprising a compressed mass of expanded graphite particles in the form of a sheet having opposed first and second major surfaces with transverse fluid channels passing through the sheet between the first and second surfaces, with at least one of the surfaces having an open top groove interconnecting with a plurality of the transverse fluid channels. The open top groove comprises a series of interconnect sheet “floors” and sheet “lands” or “walls” which cooperate to form a groove along at least one of the surfaces of the sheet.

The transverse fluid channels passing through the sheet between the opposed first and second surfaces are advantageously formed by mechanically impacting a surface of the sheet to displace graphite within the sheet at a plurality of predetermined locations to provide the channels with openings at the first and second opposed surfaces. In a particular embodiment, the transverse channel openings at one of the parallel opposed surfaces are smaller than their respective openings at the other opposed surface whereby pressurized fluid in contact with the opposed surface having the smaller channel openings enters the respective channels at an initial velocity which is greater than the velocity of the fluid exiting the respective channels, i.e., the gas exit velocity is slowed. Likewise, pressurized fluid in contact with the opposed surface having the larger channel openings has higher gas exit velocity. The transversely channeled sheet is further mechanically impacted at one of its opposed surfaces, to displace graphite within the sheet and provide in the surface of the article a preferably continuous open top groove which interconnects with a plurality of the transverse fluid channels. The mechanical impacting can be suitably accomplished by molding, pressing or embossing. An open top groove can also be provided by engraving or etching techniques. Most advantageously, however, the groove is formed in the sheet after formation of the transverse channels, for reasons that will be explained hereinbelow.

The article of the present invention is useful as a substrate for forming a fluid permeable e.g. gas diffusing electrode for an electrochemical fuel cell having an integral gas diffusing element. In accordance with the present invention, a cover element for the grooved surface is also provided, in the form of roll-pressed and calendered anisotropic flexible graphite sheet which enhances heat transfer performance of the gas diffusing electrode in electrochemical fuel cells as hereinafter described.

### BRIEF DESCRIPTION OF THE DRAWINGS

FIG. 1 is a plan view of a transversely permeable sheet of flexible graphite having transverse channels in accordance with the present invention;

FIG. 1(A) shows a flat-ended protrusion element used in making the channels in the perforated sheet of FIG. 1;

FIG. 2 is a side elevation view in section of the sheet of FIG. 1;

FIGS. 2(A), (B), (C) show various suitable flat-ended configurations for transverse channels in accordance with the present invention;

FIGS. 3, 3(A) shows a mechanism for making the article of FIG. 1;

FIG. 4 shows an enlarged sketch of an elevation view of oriented expanded graphite particles of flexible graphite sheet material;

FIG. 5 is a sketch of an enlarged elevation view of an article formed of flexible graphite sheet having transverse channels for use with the present invention;

FIG. 6 is a top plan view of an article formed of the sheet material of FIG. 1 having a continuous open-top groove formed in its upper surface in accordance with the present invention;

FIG. 6(A) is a sectional side elevation view of the material of FIG. 6;

FIG. 6(B) is a sectional side elevation view of material of FIG. 1 having a continuous open-top groove in its bottom surface in accordance with the present invention;

FIG. 6(C) is a top plan view of a position of FIG. 6;

FIG. 7 shows the sheet material of FIG. 6 having a channel covering element;

FIG. 8 is a partially fragmented perspective view of the material of FIG. 7;

FIGS. 9, 10 and 10(A) show a fluid permeable electrode assembly which includes the article of FIG. 6 in accordance with the present invention.

### DETAILED DESCRIPTION OF THE INVENTION

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the flexible sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, such as for fuel cell applications, the graphite employed will have a purity of at least about 99%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 1 25° C. to promote reaction of the reducing agent and intercalant coating. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1200° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, fluoro-based polymers, or mixtures thereof. Suitable epoxy resin systems include those based on diglycidyl ether or bisphenol A (DGEBA) and other multifunctional resin systems; phenolic resins that can be employed include resole and novolac phenolics. Optionally, the flexible graphite may be impregnated with fibers and/or salts in addition to the resin or in place of the resin.

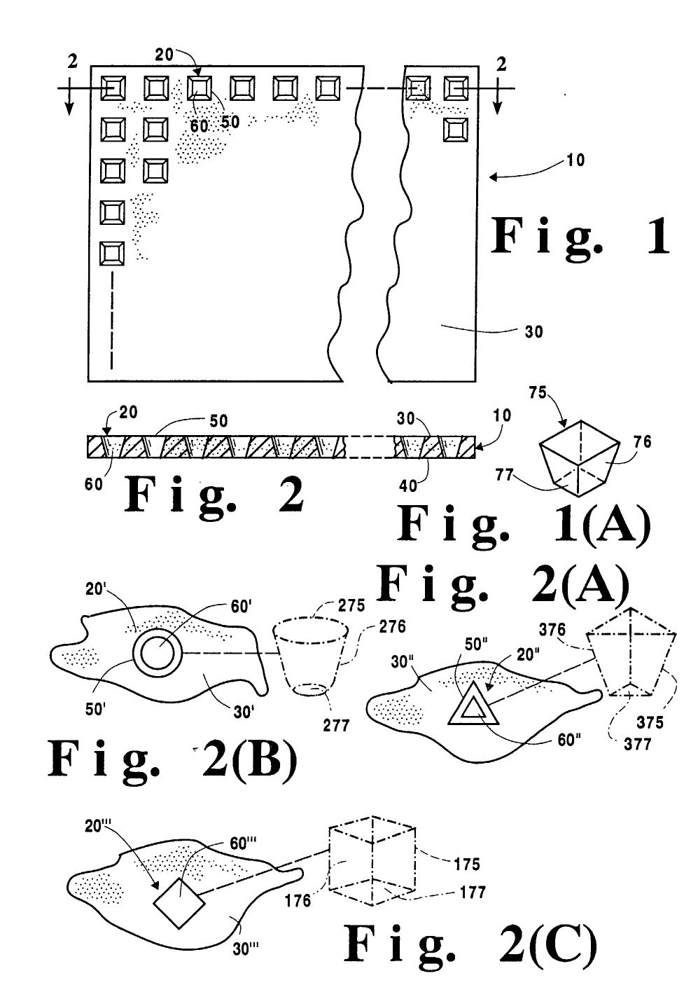

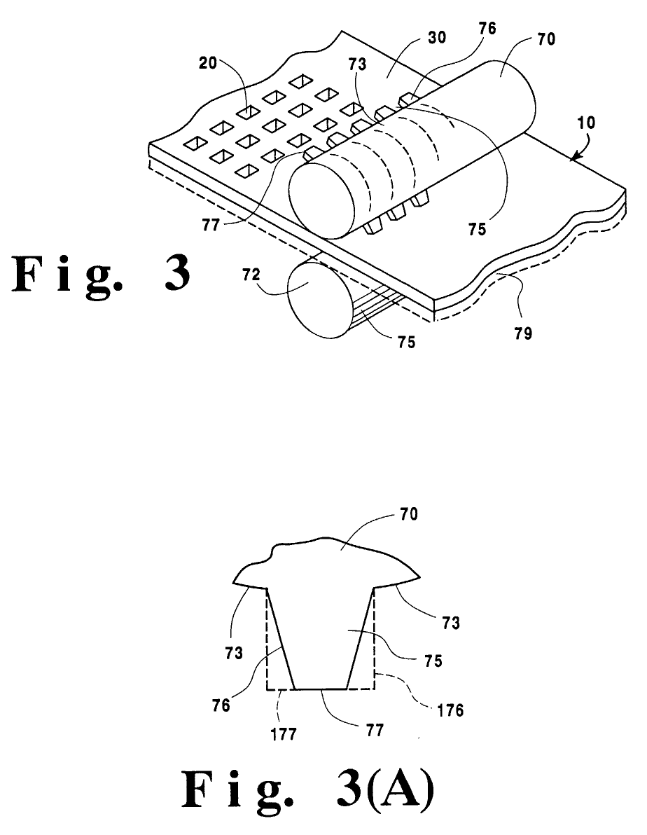

With reference to FIG. 1 and FIG. 2, a compressed mass of expanded graphite particles, in the form of a flexible graphite sheet is shown at 10. The flexible graphite sheet 10 is provided with channels 20, which are preferably smooth-sided as indicated at 67 in FIGS. 5 and 8, and which pass between the parallel, opposed surfaces 30, 40 of flexible graphite sheet 10. The channels 20 preferably have openings 50 on one of the opposed surfaces 30 which are larger than the openings 60 in the other opposed surface 40. The channels 20 can have different configurations as shown at 20′-20′″ in FIGS. 2(A), 2(B), 2(C) which are formed using flat-ended protrusion elements of different shapes as shown at 75, 175, 275, 375 in FIGS. 1(A) and 2(A), 2(B), 2(C), suitably formed of metal like steel and integral with and extending from the pressing roller 70 of the impacting device shown in FIG. 3. The smooth flat-ends of the protrusion elements, shown at 77, 177, 277, 377, and the smooth bearing surface 73, of roller 70, and the smooth bearing surface 78 of roller 72 (or alternatively flat metal plate 79), ensure deformation and displacement of graphite within the flexible graphite sheet, i.e. there are preferably no rough or ragged edges or debris resulting from the channel-forming impact. Preferred protrusion elements have decreasing cross-section in the direction away from the pressing roller 70 to provide larger channel openings on the side of the sheet that is initially impacted. The development of smooth, unobstructed surfaces 63 surrounding channel openings 60, enables the free flow of fluid into and through smooth-sided (at 67) channels 20.

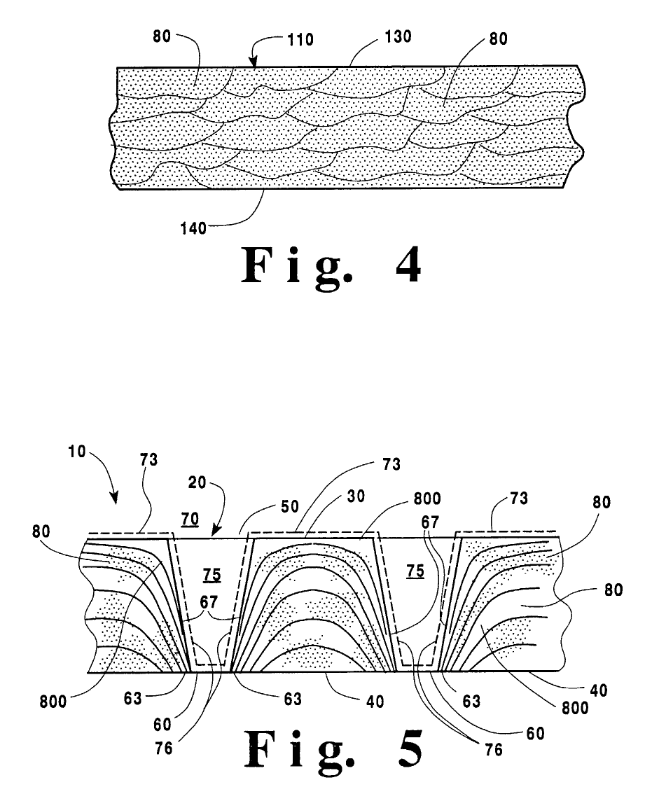

In a preferred embodiment, openings one of the opposed surfaces are larger than the channel openings in the other opposed surface, e.g., from 1 to 200 times greater in area, and result from the use of protrusion elements having converging sides such as shown at 76, 276, 376. The channels 20 are formed in the flexible graphite sheet 10 at a plurality of pre-determined locations by mechanical impact at the predetermined locations in sheet 10 using a mechanism such as shown in FIG. 3 comprising a pair of steel rollers 70, 72 with one of the rollers having truncated, i.e., flat-ended, prism-shaped protrusions 75 which impact surface 30 of flexible graphite sheet 10 to displace graphite and penetrate sheet 10 to form open channels 20. In practice, both rollers 70, 72 can be provided with “out-of-register” protrusions, and a flat metal plate indicated at 79, can be used in place of smooth-surfaced roller 72. FIG. 4 is an enlarged sketch of a sheet of flexible graphite 110 that shows a typical orientation of compressed expanded graphite particles 80 substantially parallel to the opposed surfaces 130, 140. This orientation of the expanded graphite particles 80 results in anisotropic properties in flexible graphite sheets, the electrical conductivity and thermal conductivity of the sheet being substantially lower in the direction transverse to opposed surfaces 130, 140 (“c ” direction) than in the direction (“a” direction) parallel to opposed surfaces 130, 140. In the course of impacting flexible graphite sheet 10 to form channels 20, as illustrated in FIG. 3, graphite is displaced within flexible graphite sheet 10 by flat-ended (at 77) protrusions 75 to push aside graphite as it travels to and bears against smooth surface 73 of roller 70 to disrupt and deform the parallel orientation of expanded graphite particles 80 as shown at 800 in FIG. 5. This region 800 of adjacent channels 20 shows disruption of the parallel orientation into an oblique, non-parallel orientation and is optically observable at magnifications of 100× and higher. In effect the displaced graphite is being “die-molded” by the sides 76 of adjacent protrusions 75 and the smooth surface 73 of roller 70 as illustrated in FIG. 5. This reduces the anisotropy in flexible graphite sheet 10 and thus increases the electrical and thermal conductivity of sheet 10 in the direction transverse to the opposed surfaces 30, 40. A similar effect is achieved with frusto-conical and parallel-sided peg-shaped flat-ended protrusions 275 and 175.

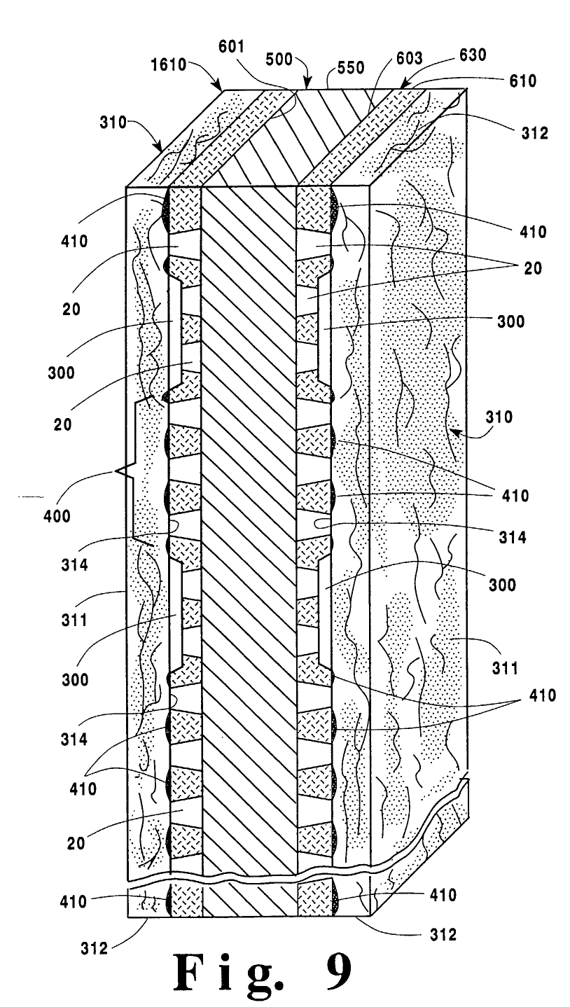

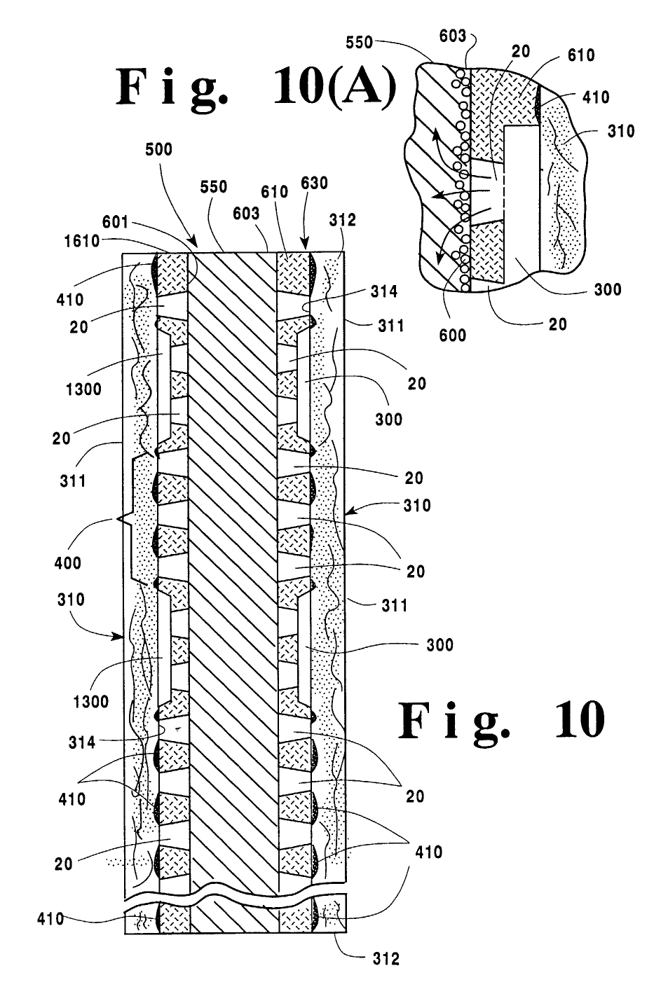

Advantageously, as illustrated in FIGS. 9 and 10, the edges of graphite sheet 10 can be allowed to remain unperforated. In other words, no channels 20 are formed in the edges of sheet 10, in order to provide a relatively gas impermeable edge for sealing purposes. Although there is no criticality to the amount of edge having no channels 20, preferably, at least about 5%, and more preferably at least about 10%, of sheet 10 extending in from the edge, has no channels 20.

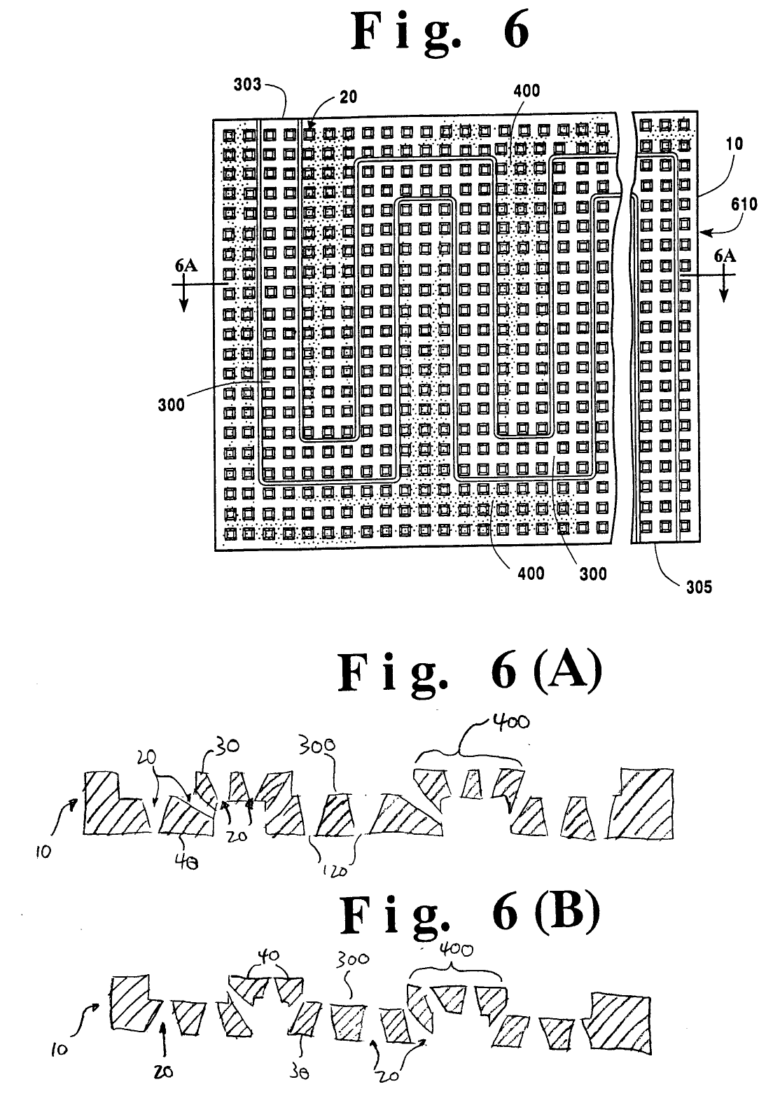

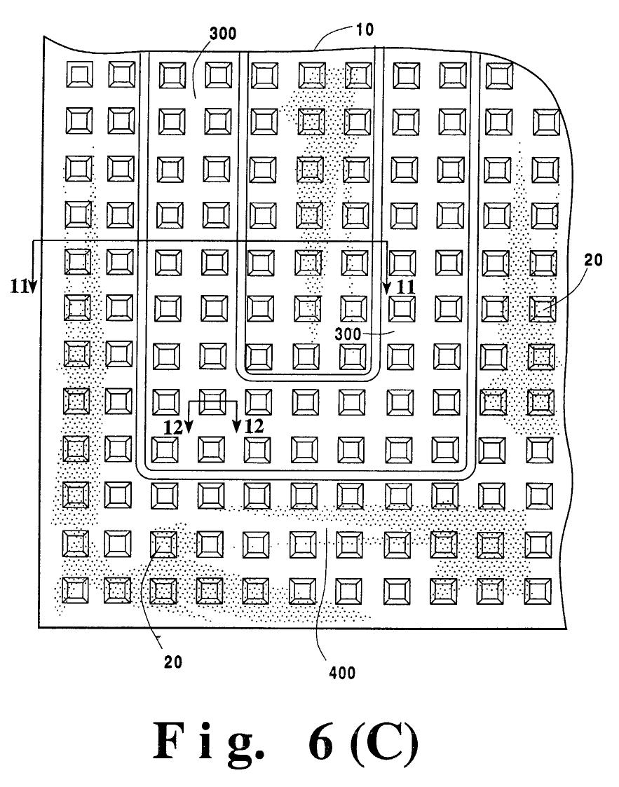

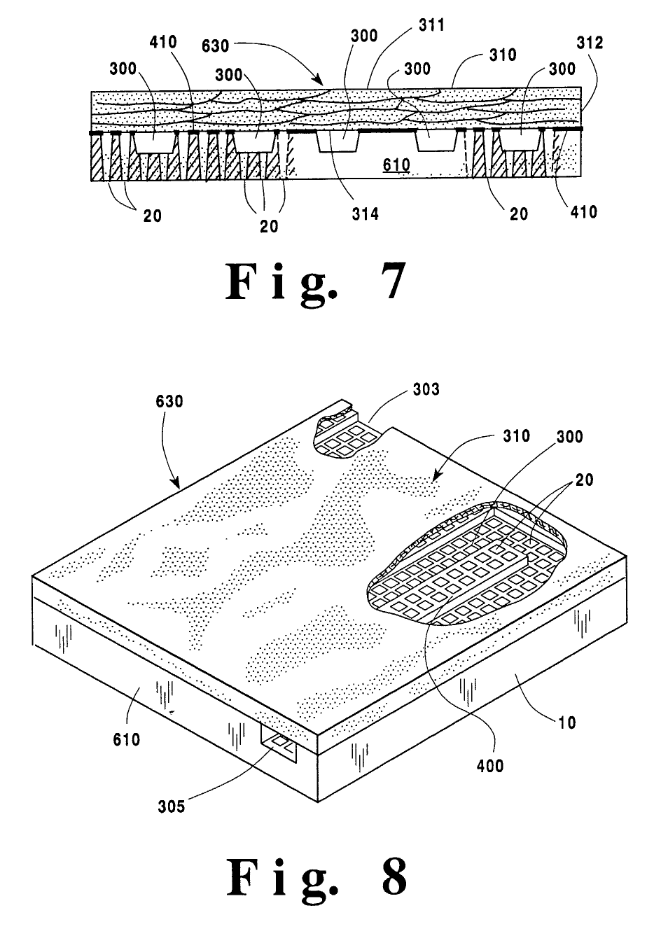

In the practice of the present invention, with reference to FIGS. 6 and 6(A), a gas permeable flexible graphite sheet 10, having transverse channels 20, as shown in FIG. 1, is provided, at its upper surface 30 with a continuous, open groove 300, fluid inlet 303 and fluid outlet 305 to constitute a gas diffusing electrode 610. FIG. 6(B) shows an alternative arrangement wherein the open groove 300 is provided in the opposite surface 40. The groove 300 of the present invention is suitably formed by pressing a hard metal die onto flexible graphite sheet material of the type shown in FIG. 2, i.e., flexible graphite sheet having transverse channels 20 passing therethrough between surface 30 and surface 40. In the preferred embodiment, the die forms a continuous open groove 300 in the surface contacted by the die, formed by groove floors 310 and groove lands or walls 320. In other embodiments, however, groove 300 can be formed in any particular pattern, such as one designed to cooperate with channels 20 to optimize efficiency or other characteristics. For a sheet of flexible graphite 0.006 inches to 0.125 inches thick, groove 300 is suitably 0.003 inches to 0.115 inches deep and having floors 310 that are 0.020 inches to 0.250 inches wide separated by walls 320 that are e.g. 0.010 inches to 0.060 inches wide.

Significantly, when open groove 300 is formed in sheet 10 after the formation of channels 20, sheet 10 assumes a “corrugated” or wave-shape in cross-section, as illustrated in FIGS. 6(A) and 6(B). Put another way, walls 320 assume a shape roughly equivalent to an inverted “u”, as opposed to being solid. Channels 20, therefore, do not only extend through sheet 10 at groove floor 310, but may also extend from one surface of sheet 10 through to the other surface all about the surface of walls 320, as illustrated. In this way, the free flow of gases, such as the fuel cell fuel or oxygen, is facilitated, and the available surface area of catalyst/membrane to which the gas is exposed is increased. Moreover, the fact that channels 20 extending through walls 320 are at various angles with respect to the plane of sheet 10 can encourage turbulence in the gases flowing through those channels 20 to the “insides” of walls 320, which can promote the fuel cell reactions.

The device shown in FIGS. 7 and 8 is an electrode 630 in the form of a combination of a grooved gas permeable body of flexible graphite 610 with a flexible graphite cover element 310.

Cover element 330 shown in FIGS. 7 and 8 is a thin flexible graphite sheet (0.003 inches to 0.010 inches) that has been roll pressed and calendered to a relatively high density, e.g 0.9. to 1.5 g/cc. The roll pressed and calendered sheet 310 has a very high degree of anisotropy with respect to thermal conductivity. The thermal conductivity in directions in the plane of the flexible graphite sheet (“a” direction) is typically 30 to 70 times the thermal conductivity in the direction through the flexible graphite sheet (“c” direction). Consequently, heat generated in the fuel cell 500 shown in FIGS. 9, 10, 10(A), e.g. at catalyst 603, due to electric current flow, is conducted through gas diffusing electrode 610 to the abutting and contiguous flexible graphite sheet covering element 310 and then rapidly conducted, parallel to the opposed surfaces 311, 314 of the graphite sheet 310, due to high heat conductivity in this direction (“a”), to the edges 312 of flexible graphite sheet cover element 310, where the heat can be readily dissipated by convection. The need for incorporating cooler cells, or elements, in a stack of fuel cells is thus minimized.

In order to achieve optimum bonding between flexible graphite sheet cover element 310 and gas diffusion electrode 610, graphite sheet cover element 330 may be impregnated with a thermosetting resin (e.g. by immersion in a solution of modified phenolic resin in alcohol) and the resin containing flexible graphite sheet 30 is placed in contact with the raised portion 400 of grooved surface 30 or 40, of gas diffusion electrode 610 and heated to cure the resin and form a bond 410 at the lands 400 of the grooved surface. This is conveniently accomplished by placing the resin impregnated cover element 310 on a flat metal surface and lightly pressing the gas diffusion electrode 610 against the resin impregnated cover element 310 while heating the cover element 310 to a temperature sufficient to cure the resin and effect bonding, typically 170° C. to 400° C. Alternatively, bonding can be accomplished by coating the raised portions 400 of the die formed grooved surface of the gas diffusion layer with a similar resin and bonding and curing the cover element in place as previously described.

FIG. 9, FIG. 10 and FIG. 10(A) show, schematically, the basic elements of an electrochemical Fuel Cell 500, more complete details of which are disclosed in U.S. Pat. Nos. 4,988,583 and 5,300,370 and PCT WO 95/16287 (15 Jun. 1995) and each of which is incorporated herein by reference.

With reference to FIG. 9, FIG. 10 and FIG. 10(A), the Fuel Cell indicated generally at 500, comprises electrolyte in the form of a plastic e.g. a solid polymer ion exchange membrane 550 catalyst coated at surfaces 601, 603, e.g. coated with platinum 600 as shown in FIG. 10(A) and a perforated and surface grooved flexible graphite sheet 610 in combination with cover element 310. Pressurized fuel is circulated through groove 300 of gas diffusing electrode 610 and pressurized oxidant is circulated through groove 1300 of gas diffusing electrode 1610. In operation, the gas diffusing electrode 610 becomes an anode and the gas diffusing electrode 1610 becomes a cathode with the result that an electric potential, i.e. voltage, is developed between the anode 610 and the cathode 1610. The above described electrochemical fuel cell is combined with others in a fuel cell stack to generate electric current and provide the desired level of electric power as described in the above-noted U.S. Pat. No. 5,300,370.

In the operation of Fuel Cell 500, the electrodes 610, 1610 are porous to the fuel and oxidant fluids, e.g. hydrogen and oxygen, adjacent to the ion exchange membrane to permit these components to readily pass from the surface groove 300 and channels 20 to contact the catalyst 600, as shown in FIG. 10(A), and enable protons derived from hydrogen to migrate through ion exchange membrane 550. In the gas permeable electrodes 610, 1610 of the present invention, transverse channels 20 are positioned adjacent surface grooves 300, 1300 of the electrode 610, 1610 so that the pressurized gas from the surface grooves 300, 1300 passes through and exits channels 20 and contacts the catalyst 600.

In the present invention, for a flexible graphite sheet having a thickness of about 0.003 inch to 0.015 inch adjacent the channels and a density of about 0.5 to 1.5 grams per cubic centimeter, the preferred channel density (or count) is from about 1000 to 3000 channels per square inch. More preferably, the channel density is at least about 1200 and most preferably at least about 2300. The preferred channel size is a channel in which the ratio of the area of larger channel opening to the smaller is from about 50:1 to 150:1; the open-top groove is preferably about 0.020 to 0.125 wide and at least about half the thickness of the sheet.

Additional advantages of the present invention when used in a fuel cell are high thermal dissipation at the periphery of the electrode, which minimizes the requirement for cooling elements in the cell, as well as a providing a relatively thin electrode and elimination of the need for one or both flow field plates.

The above description is intended to enable the person skilled in the art to practice the invention. It is not intended to detail all of the possible variations and modifications which will become apparent to the skilled worker upon reading the description. It is intended, however, that all such modifications and variations be included within the scope of the invention which is defined by the following claims. The claims are intended to cover the indicated elements and steps in any arrangement or sequence which is effective to meet the objectives intended for the invention, unless the context specifically indicates the contrary.

What is claimed is:

1. A graphite article comprising a compressed mass of expanded graphite particles in the form of a sheet having opposed first and second surfaces, the sheet having a plurality of transverse fluid channels passing therethrough between its first and second opposed surfaces, one of the opposed surfaces having formed therein an open groove which communicates with a plurality of the transverse fluid channels,
wherein the open groove comprises a groove floor and groove walls, the groove walls having transverse fluid channels passing therethrough.

2. The article of claim 1 wherein the channels are formed by mechanically impacting the first surface of the sheet at a plurality of locations to displace graphite within the sheet at the locations and provide the channels with openings at both of the first and second opposed surfaces.

3. The article of claim 1 wherein the open groove is provided with a cover in the form of a flexible graphite sheet bonded to the surface in which the groove is formed.

4. The article of claim 3 wherein the open groove is provided with a cover in the form of roll pressed and calendered flexible graphite sheet bonded to the surface in which the groove is formed.

5. The article of claim 1 wherein the open groove is formed after formation of the channels.

6. The article of claim 5 wherein the open groove is formed by mechanically impacting a surface of the sheet to displace graphite within the sheet.

7. A substrate suitable for formation of a component for an electrochemical fuel cell comprising (i) a compressed mass of expanded graphite particles in the form of a sheet having opposed first and second surfaces, the sheet having a plurality of transverse fluid channels passing therethrough; one of the opposed surfaces having formed therein an open groove which communicates with a plurality of the transverse fluid channels and (ii) a sheet of flexible graphite bonded to the surface in which the groove is formed to provide a cover therefore,
wherein the open groove comprises a groove floor and groove walls, the groove walls having transverse fluid channels passing therethrough.

8. The substrate of claim 7 wherein the channels are formed by mechanically impacting the first surface of said sheet at a plurality of locations to displace graphite within sheet and provide the channels with openings at both of the first and second opposed surfaces.

9. The substrate of claim 7 wherein the channels are formed by mechanically impacting the first surface of the sheet at a plurality of locations to displace graphite within the sheet at the locations and provide the channels with openings at both of the first and second opposed surfaces.

10. The substrate of claim 7 wherein the open groove is provided with a cover in the form of a flexible graphite sheet bonded to the surface in which the groove is formed.

11. The substrate of claim 10 wherein the open groove is provided with a cover in the form of roll pressed and calendered flexible graphite sheet bonded to the surface in which the groove is formed.

12. The substrate of claim 7 wherein the open groove is formed subsequent to formation of the channels.

13. The substrate of claim 12 wherein the open groove is formed by mechanically impacting a surface of the sheet to displace graphite within the sheet.

14. A method for forming a graphite article comprising providing a compressed mass of expanded graphite particles in the form of a sheet having opposed first and second surfaces, forming in the sheet a plurality of transverse fluid channels passing therethrough between its first and second opposed surfaces, forming on one of the opposed surfaces of the sheet an open groove which communicates with a plurality of the transverse fluid channels,
wherein the open groove comprises a groove floor and groove walls, the groove walls having transverse fluid channels passing therethrough.

15. The method of claim 14 wherein the channels are formed by mechanically impacting the first surface of the sheet at a plurality of locations to displace graphite within the sheet at the locations and provide the channels with openings at both of the first and second opposed surfaces.

16. The method of claim 14 which further comprises providing the open groove with a cover in the form of a flexible graphite sheet bonded to the surface in which the groove is formed.

17. The method of claim 16 which further comprises providing the open groove with a cover in the form of roll pressed and calendered flexible graphite sheet bonded to the surface in which the groove is formed.

18. The method of claim 14 wherein the open groove is formed after formation of the channels.

19. The method of claim 18 wherein the open groove is formed by mechanically impacting a surface of the sheet to displace graphite within the sheet.
